(19) United States
(12) Patent Application Publication
(10) Pub. No.: US 2012/0255648 A1
(43) Pub. Date: Oct. 11, 2012

(54) Log Chipper with Log Jam Clearing Feature

(76) Inventor: David A. Gray, Lexington, SC (US)

(21) Appl. No.: 13/084,095

(22) Filed: Apr. 11, 2011

Related U.S. Application Data
(60) Provisional application No. 61/473,231, filed on Apr. 8, 2011.

(51) Int. Cl. B27L 11/00

(52) U.S. Cl. 144/242.1; 241/34

(57) ABSTRACT

A wood chipper includes an in-feed spout with an input end and an opposing feeding end, a motor-turned chipper blade to receive logs at the feeding end, and one or a pair of independently-operable, hydraulic arms movable between a first position external to the in-feed spout and a second position internal to the in-feed spout through a gap in the in-feed spout. When inserted, the arms clear jammed logs laying anywhere across the width of the in-feed spout. The arms are operated by hydraulic rams secured to a bracket, preferably attached to a cover over a portion of the in-feed spout near the chipper blade and in proximity to the gap in the in-feed spout.

### PRIORITY CLAIM

Claim is made to the priority benefit of U.S. provisional patent application Ser. No. 61/473,231 filed Apr. 8, 2011, which application is incorporated herein in its entirety by reference.

### DETAILED DESCRIPTION OF PREFERRED EMBODIMENTS

A wood chipper is a device that reduces logs to wood chips, typically for the paper industry but also for other applications. The logs are fed into the chipper by placing them in a hopper or on a conveyor leading to a chipper blade. At times, the logs may become jammed and the chipping process must be halted to clear the jam so that the logs again feed into the chipper. Logs are jammed when they are not advancing toward the chipper because of their mutual interference in the hopper or conveyor. There are several devices for use in clearing jammed logs being fed into the chipper, such as those shown and described in U.S. Pat. No. 5,477,900, U.S. Pat. No. 6,146,350 and U.S. Pat. No. 6,941,987, which are incorporated herein in their entirety by reference.

### SUMMARY OF THE INVENTION

According to its major aspects and briefly recited, the present invention is a wood chipper with a horizontal in-feed and a log jam clearing feature to clear log-jams in the horizontal in-feed. The log clearing feature can also be added to prior art chippers. The wood chipper includes an in-feed spout and a chipper blade; the log jam clearing features includes an arm system that has the capability of clearing logs jammed in the in-feed spout. The in-feed spout, placed horizontally, leads to the chipper blade. Openings in the floor of the in-feed spout provide contact between logs and rotating rollers that urge the logs forward toward the chipper blade. The arm system includes one or two independently movable lifting arms that may be moved from a first position external to the in-feed spout to a second position internal to the in-feed spout to lift the logs up from the floor of the in-feed spout to clear the jam. The arms are moved by hydraulic rams and, whether one or two arms, extend across the width of the in-feed spout so that any log on the in-feed spout may be lifted by at least one of the two arms.

### BRIEF DESCRIPTION OF THE DRAWINGS

In the figures,

FIG. 1A is a partial, right front perspective view of the present wood chipper, according to an embodiment of the present invention;

FIG. 1B is a top view of the present wood chipper, according to an embodiment of the present invention;

FIG. 1C is a partial, side view of the present wood chipper, according to an embodiment of the present invention;

FIG. 2 is an exploded, perspective view of the log jam clearing feature and log feeding in-feed spout of the present wood chipper, according to an embodiment of the present invention;

FIGS. 3A, 3B and 3C are end views of a portion of the present log jam clearing feature and log feeding in-feed spout of a wood chipper, with both arms down in FIG. 3A, a left arm up but right arm down in FIG. 3B, and both arms up in FIG. 3C, according to an embodiment of the present invention;

FIG. 4 is a perspective view of an alternative log jam clearing feature and feeding in-feed spout of a wood chipper, according to an alternative embodiment of the present invention;

FIGS. 5A, 5B and 5C are end views of the alternative embodiment of a wood chipper as seen in FIG. 4, showing both arms withdrawn in FIG. 5A, with a left arm only in lifting position in FIG. 5B, and with both left and right arms in lifting positions in FIG. 5C;

FIG. 6 is an end view of a second alternative embodiment of a wood chipper, showing a single arm operated by a single ram for lifting logs in the in-feed spout, with the external position of the arm shown in dashed lines and the internal position of the arm shown in solid lines, according to an embodiment of the invention;

FIG. 7 is a schematic diagram showing a control system for a wood chipper log jam clearing feature with two arms, such as that shown in FIGS. 5A, 5B and 5C;

FIGS. 8A and 8B are top left perspective views of a third alternative log jam clearing feature and the feeder in-feed spout of a wood chipper with the arm in the external position in FIG. 8A and in the inserted position in FIG. 8B; and

FIGS. 9A and 9B are front views of still a fourth alternative log jam clearing feature and the feeder in-feed spout of a wood chipper with the arm in the external position in FIG. 9A and in the inserted position in FIG. 9B.

### DETAILED DESCRIPTION OF PREFERRED EMBODIMENTS

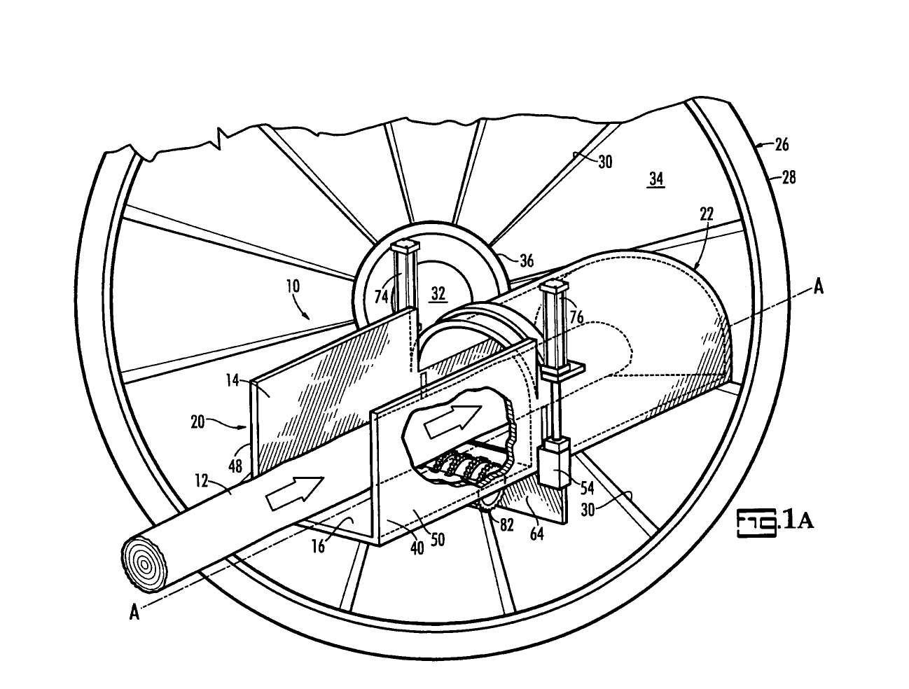

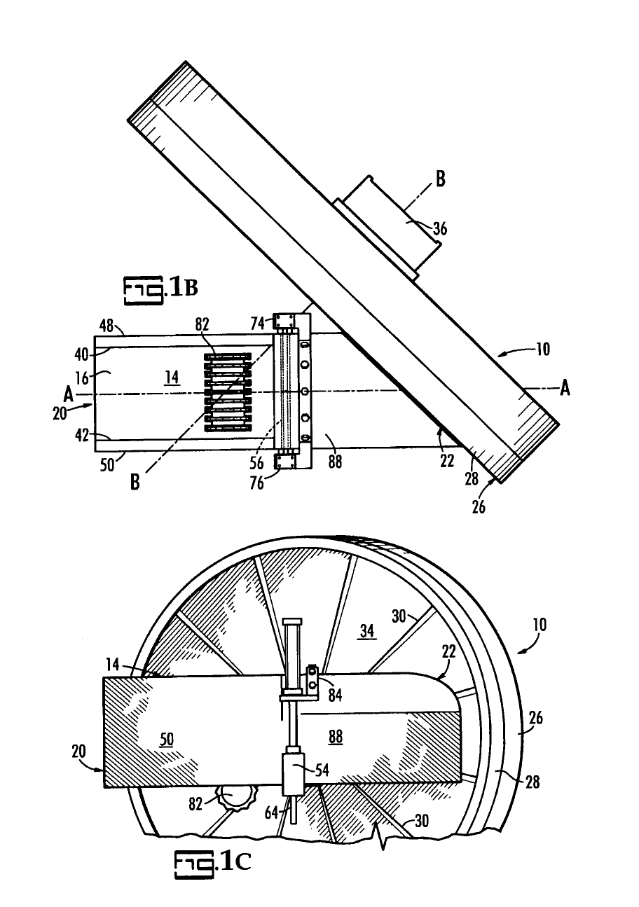

Referring now to the FIGS. 1-3A, 3B and 3C, the present invention is a wood chipper, generally indicated by reference number 10. Wood chipper 10 receives whole or cut up logs 12, and turns them into wood chips.

Wood chipper 10 includes an in-feed spout 14 with a floor 16 running from an input end 20 to a feeding end 22, thereby defining a long dimension A. Long dimension A lies in a plane that is substantially horizontal. In-feed spout 14 is therefore positioned horizontally. Substantially horizontal means that allowing for unevenness of the ground or surface on which wood chipper 10 is placed, in-feed spout 14 is not particularly higher or lower at input end 20 than at feeding end 22. Logs 12 are placed on floor 16 of in-feed spout 14 at input end 20 and advanced toward feeding end 22.

At feeding end 22 is a chipper disc 26, which is a large disc with a drive hub 32. Chipper disc 26 is divided into segments 34 radiating from drive hub 32, each segment 34 having a knife 30 clamped to it. A motor 36 rotates chipper disc 26 so that knives 30 sheer off chips of wood from logs 12 as those logs 12 advance from input end 20 to feeding end 22 and into the face of rotating chipper disc 26.

Chipper disc 26 has an axis of rotation B (see FIG. 1 B) that may be at an angle greater than zero with respect to long dimension A of in-feed spout 14. Long dimension A and axis B may lie either in the same plane, may lie in planes parallel to each other and both will be horizontal if in-feed spout 14 is horizontal, or may lie in different planes. The present invention is for a horizontally-oriented in-feed spout 14 feeding to chipper disc 26, regardless of the orientation of blade 26 with respect to in-feed spout 14.

Floor 16 of in-feed spout 14 has a first side 40 and an opposing second side 42 with a first wall 48 on first side 40 and a second wall 50 on second side 42, and a width defined by the distance between the first side 40 and the second side 42. Logs 12 in in-feed spout 14 are confined to this width by first wall 48 and second wall 50 and oriented roughly parallel to long dimension A of in-feed spout 14 and supported by floor 16. In-feed spout 14 is intended to be in a horizontal orientation when in use.

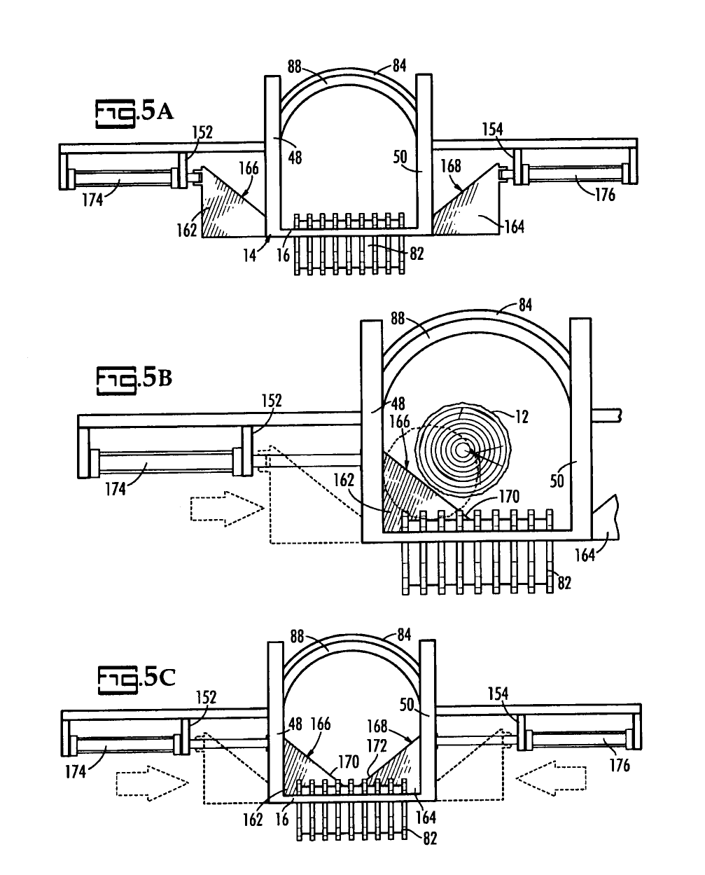

In-feed spout 14 has a narrow gap 56 formed therein that crosses floor 16 from first wall 48 to second wall 50 and which may be perpendicular to long dimension A. Below gap 56 is an arm system that has at least one arm, as illustrated in FIG. 6, or it may have two arms 62, 64, as shown, and opposing each other from the first side 40 and second side 42 of in-feed spout 14, respectively, as illustrated in two embodiments in FIGS. 1-5C, or more than two arms if additional arms are stacked behind others perpendicular to long dimension A. First and second arms 62, 64 may be used cooperatively or independently to clear jammed logs. First and second arms 62, 64, have a first position external to in-feed spout 14, which may be at or below floor 16 and proximate to gap 56, and a second position inserted into in-feed spout 14, by moving above floor 16 through gap 56. First and second arms 62, 64, move through gap 56 when moving between their external first position and their inserted second position. Whether arm system 60 has one arm or two arms, as illustrated, or more than two arms, the arms may span the width of in-feed spout 14 when in their inserted second position. Alignment of arms 62, 64, is maintained by guides 52, 54, respectively

In the case of arm system 60 having a first and a second arm 62, 64, first arm 62 and second arm 64 extend toward each other when inserted into in-feed spout 14 so as to be close enough so that any log 12 in in-feed spout 14 at gap 56 will be lifted by the vertical movement of at least one of first arm 62 and second arm 64 as at least one of arms 62, 64, moves from the external first position to the inserted second position.

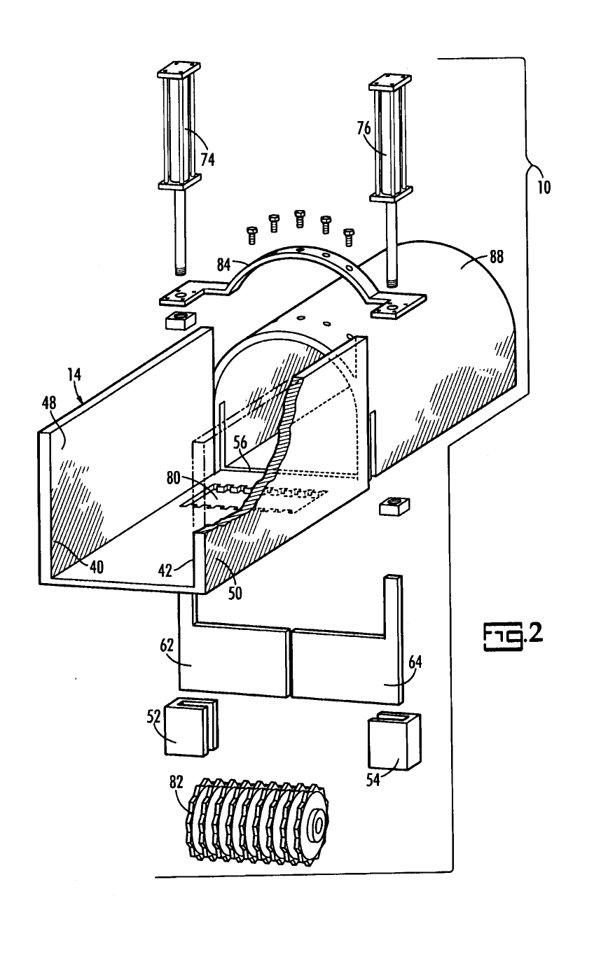

As seen in FIGS. 3A-3C, both arms 62, 64 may be in the external or down position (FIG. 3A) or only first arm 62 may be in the inserted or up position while second arm 64 may be in the external or down position (FIG. 3B) or vice versa; or, alternatively, both first and second arms 62, 64, may be in the inserted or up position (FIG. 3C). The lifting of logs 12 in in-feed spout 14 by independently operated first and second arms 62, 64 of the arm system is believed to contribute to the clearing of a log jam in wood chipper 10. The ability to lift any log across the width of in-feed spout 14, and preferably to lift logs lying across gap 56 anywhere across the width of in-feed spout 14, means that jams are more readily cleared. Clearing jams of logs in a horizontal in-feed spout of a chipper means that logs do not have to be lifted away from chipper disc 26, parallel to at least a component of the long dimension A, as they do in a vertical or inclined hopper or chute, which retards productivity and may merely push the jammed logs rearward or upward without addressing the cause of the jam or separating the jammed logs.

Movement of the arm system of FIGS. 1-3A, 3B and 3C is caused by a corresponding ram system in operating connection with the arm system. The ram system includes one or plural rams, which may be hydraulic rams, pneumatic rams, electric-powered screw rams, or steam-driven rams. Rams 74, 76, are positioned so as to control first and second arms 62, 64, respectively, between their external first and inserted second positions. In the case of a first and a second arm 62, 64, two rams, a first ram 74 and a second ram 76 are located on either side of in-feed spout 14 proximate to gap 56. Each ram 74, 76, is oriented vertically and located on opposite sides of in-feed spout 14, as shown, to lift a different arm 62, 64, respectively, and may do so independently or in a coordinated manner, that is, moving each arm 62, 64, a little more or less than the other or symmetrically, as the use determines to be effective in clearing the jammed logs. Arm 62 can be lifted by ram 74 to the inserted second position while arm 64 remains stationary in its external first position; conversely, second arm 64 may be lifted to the inserted second position while first arm 62 remains in its external first position. A skilled operator can determine which arm 62, 64, to lift in clearing a jam.

Lifting a log 12 allows it to re-orient itself with respect to adjacent logs 12 and thereby helps to clear a log jam. Prior art wood chippers had rams that were not always positioned to lift each long and which pushed them away from their chipper blades. First and second rams 74, 76, do not enter the in-feed spout but operate through first and second arms 62, 64, respectively, and do not push logs back away from chipper disc 26 but rather lift them so that, for example, a log 12 on the left side of in-feed spout 14 is lifted clear of a second log 12 on the right side of in-feed spout 14 by first arm 62, and thereby eliminates the interference of the second log 12 with the first log 12. Meanwhile, the second log 10 can proceed toward chipper disc 26 so productivity is not lost yet the jam is effectively cleared.

Floor 16 of wood chipper 10 has one or more openings 80 formed in it for one or more horizontal rollers 82, mounted below in-feed spout 14 at openings 80, to engage and urge logs 10 forward from input end 20 of in-feed spout 14 to feeding end 22. Rollers 82 may have fingers 86 on their peripheral surface to grip logs 12 and push them forward. Rollers 82 may be rotated by a motor (not shown) so their upper surfaces that are engaging logs 12 apply pressure on logs 10 particularly when they are engaging chipper disc 26.

Feeder end 22 of in-feed spout 14 may have a cover 88 as a safety shield to prevent workers from getting too close to chipper disc 26 and to guard against flying wood chips causing injury. A bracket 84 may be carried on cover 88 and used to secure and hold first and second rams 74, 76, in alignment with each other so that first and second arms 62, 64 maintain their orientations with respect to each other with when moving through gap 56 between the external first position and the inserted second position. It will be clear that a pre-existing chipper with in-feed spout may be back-fitted with a bracket 84 to a pre-existing cover by altering the shape of bracket 84 to conform to the pre-existing cover or by replacing the pre-existing cover with a cover 88. An arm system and ram system may then be added to the pre-existing chipper in accordance with the present invention in the embodiment described in connection with FIGS. 1-3C or with those alternative embodiments presented below.

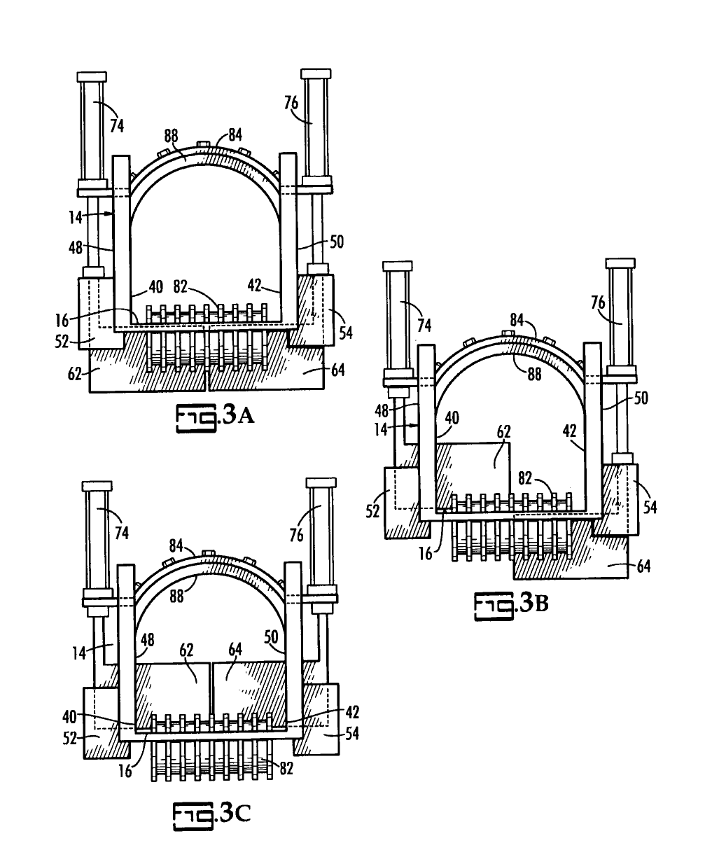

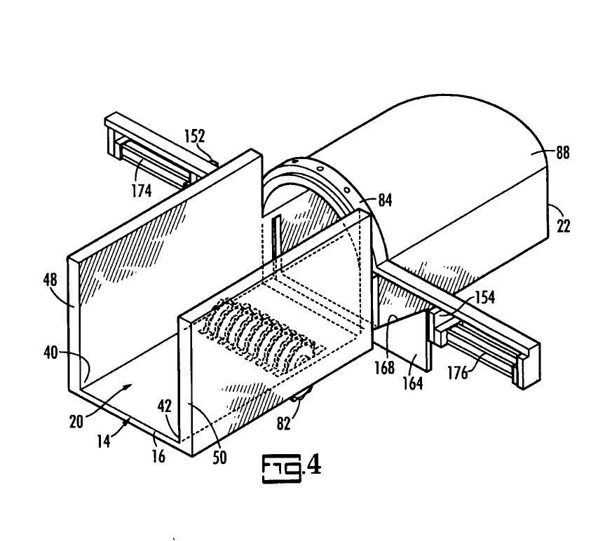

FIGS. 4, 5A, 5B and 5C illustrate a portion of an alternative embodiment of the present wood chipper. FIG. 4 may be compared to FIG. 1 to see that chipper disc 26 and motor 36 which are shown in FIG. 1 are not shown in FIG. 4, but which components are nonetheless a part of this alternative embodiment but are simply not shown in FIG. 4 for simplicity, with only in-feed spout 14 and an alternative log jam clearing feature remaining.

Features shown in FIG. 4 that are present in FIG. 1 and serve the same function, such as in-feed spout 14 with its floor 16, its opposing edges 40, 42, its opposing walls 48, 50, roller 82, input end 20 and feeding end 22, cover 88 and bracket 84, are identified by the same reference numbers as in FIG. 1. The principal differences are in the arm system and ram system.

The arm system of FIGS. 4, 5A, 5B and 5C, has an external position, wherein a left arm 162 and a right arm 164 are lateral and external to in-feed spout 14, and an inserted position, wherein left arm 162 and right arm 164 are inserted into in-feed spout 14 from their initial, lateral position. Unlike the embodiment of FIG. 1, however, arms 162 and 164 are moved laterally rather than vertically from their external positions to their inserted positions. Furthermore, left arm 162 and right arm 164 are formed to have inclined top surfaces 166, 168, respectively. On being moved from their external positions to their inserted positions, assisted by guides 152, 154, top surfaces 166, 168 of left arm 164 and right arm 166, respectively, cam any logs 12 upwards and towards the center of in-feed spout 14 as the leading, lowest edges 170, 172, of left arm 162 and right arm 164, respectively, enter in-feed spout 14 first through a gap 156 in walls 48, 50 of in-feed spout 14.

The ram system includes a left ram 174 and an opposing right ram 176, both oriented horizontally, so that they can move left arm 162 and right arm 164, respectively, laterally between their lateral, external first positions and their inserted second positions inside in-feed spout 14. FIG. 5A illustrates left arm 162 and right arm 164 in their lateral, external first positions. FIG. 5B illustrates left arm 162 moved to its inserted second position by left ram 174 whereby log 12 is moved vertically and centered by top surface 166, as shown. FIG. 5C illustrates both left and right arms 162, 164, respectively, moved to the inserted positions in in-feed spout 14 by left and right rams 174, 176, respectively.

FIG. 6 illustrates another alternative embodiment of the present invention, as seen from the end. As with the alternate embodiment of FIGS. 4, 5A-5C, many of the components are the common to the first embodiment, illustrated in FIGS. 1, 2, 3A-3C and those components are either not illustrated in FIG. 6 or have the same reference number where they are illustrated.

The principal differences are that in the embodiment of FIG. 6 there is one arm 262 and one hydraulic (or pneumatic) ram 276. Ram 276 moves arm 262 laterally from one side of in-feed spout 14 through a gap (not visible in FIG. 6) in wall 48, as illustrated in FIG. 6. Arm 262 is preferably angled as in the case of arms 162, 164 shown in FIGS. 5A-5C. Arm 262 may be formed with a shallower angle that arms 162, 164, which angle may be less than 45 degrees, but, when moved from its first position (illustrated in dashed lines in FIG. 6) to its second position (illustrated in solid lines in FIG. 6), assisted by an upper and a lower guide 252, 254, arm 262 extends across the width of in-feed spout 14 and cams log 12 upward. Log 12 may be anywhere between walls 48-50, that is, across the width of in-feed spout 14, and arm 262 may clear jammed log 12 as a result of lifting log 12.

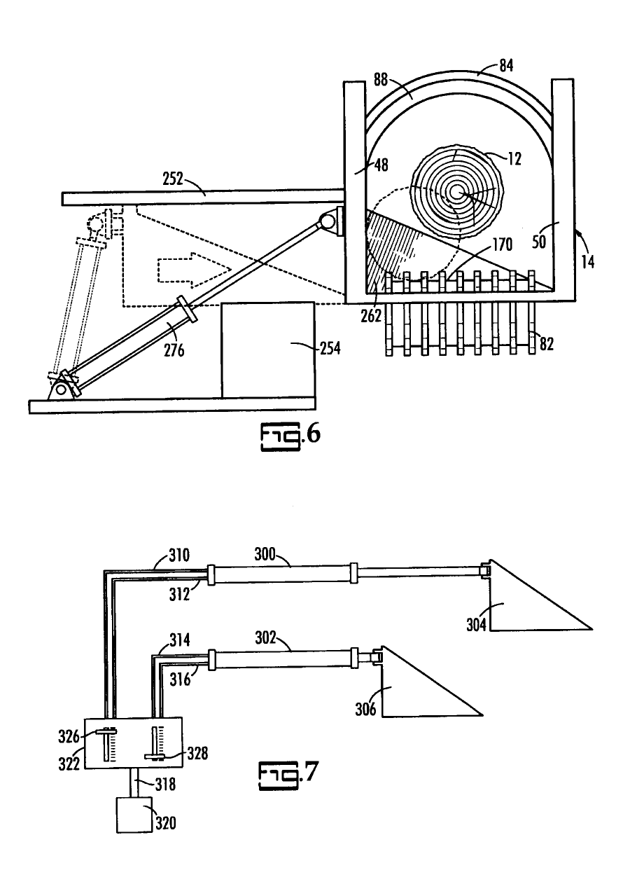

FIG. 7 illustrates a schematic view of a control system for a two-arm log jam clearing feature. A first ram 300 and a second ram 302 with arms 304 and 306, respectively, are connected by hoses 310, 312, 314, 316, and 318 to a source of hydraulic or pneumatic fluid 320 through a control box 322 positionable in the vicinity of wood chipper 10. Slide switches 326, 328, or equivalent control valves (not shown) in control box 322 to adjust the direction of flow of the hydraulic fluid through the respective hoses 310, 312, 314, 316, of rams 300, 302 to move them between the external position (slide switch down in FIG. 6) and the inserted position. Arm 304 is in the inserted position as its slide switch 326 is in a position to force hydraulic fluid into ram 300. Arm 306 is in the external position as its slide switch 328 is in a position to withdraw hydraulic fluid from ram 302.

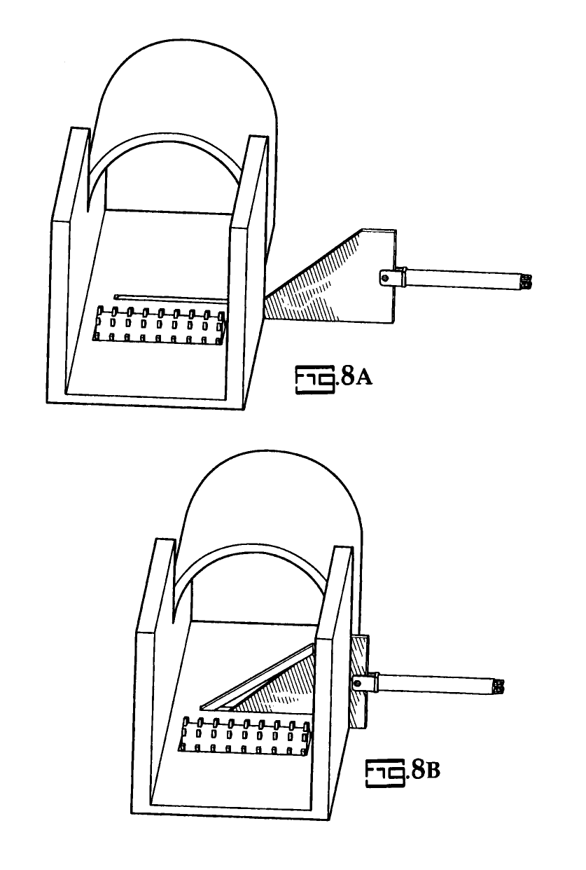

FIGS. 8A and 8B illustrate a second alternative embodiment of a log jam clearing feature. Both FIG. 8A and FIG. 8B show in-feed spout 14 and this alternative log jam clearing feature from the front right perspective. In FIG. 8A, an arm 400 laterally movable by a ram 402 is shown in its external first position; in FIG. 8B, arm 400 has been moved laterally to its inserted second position with in-feed spout 14. A ramp 404 pivotally attached to floor 16 so that its lateral end 406 is free to move upward as arm 400 is moved to the second position shown in FIG. 8B from the first position, arm 400 camming ramp 404 up from its normal position flush with floor 16. A log resting on floor 16 anywhere across the width of floor 16 can be raised by moving arm 400 from the first position to the second position without arm 400 scraping and possibly damaging the log from direct contact. While a single arm 400 operated by a single ram 402 are illustrated in FIG. 8A and 8B, it will be clear that two arms with two independently operated rams may be used with each arm having its own ramp 404

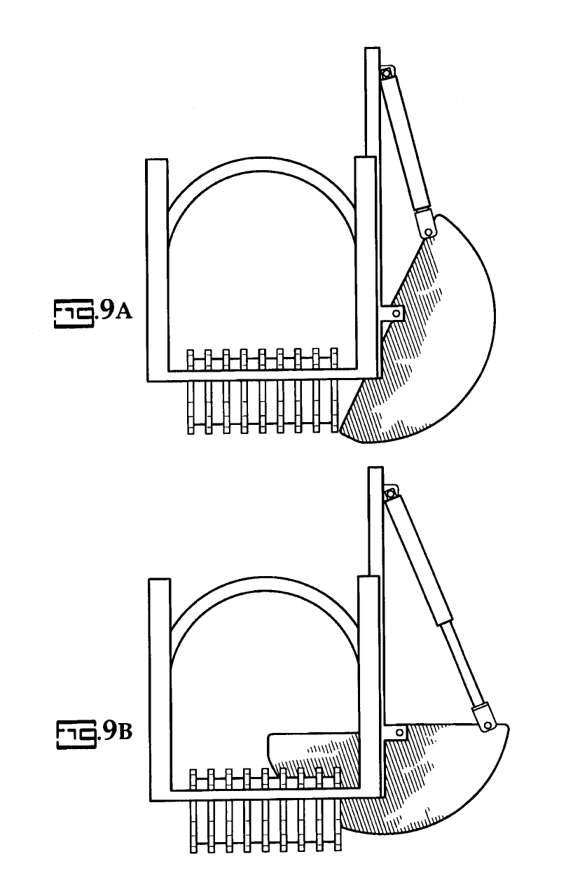

FIGS. 9A and 9B illustrate a third alternative embodiment of a log jam clearing feature. Both FIG. 9A and FIG. 9B show in-feed spout 14 and the third alternative log jam clearing feature from the front, with FIG. 9A showing an arm 500 held in the external first position by a ram 502 and in the inserted second position in FIG. 9B with ram 502 extended. Arm 500 pivots about a pivot pin 504 attached to second wall 50 so that arm 500 pivots up from a gap (not shown in FIG. 9B) in floor 16. Ram 502 may be capable of rotating arm 500 so that, inside in-feed spout 14, arm 500 rises above a position level with floor 16. Also, although one arm 500 operated by one ram 502 are shown in FIGS. 8A and 8B, two arms, each operated independently, may be provided so that logs anywhere across the width of floor 16 may be lifted to clear a log jam.

It will be clear to those of ordinary skill that other control systems and configurations of arms that move from positions exterior to in-feed spout 14 to positions interior to in-feed spout 14 in such a way that logs 12 are lifted from the floor 16 of a horizontal in-feed spout 14 in order to clear them as part of the wood chipping process, can be generated from combinations of these various embodiments. Importantly, arms 62, 64, 162, 164, 253, 400, 500, lift logs 12 vertically from floor 16 of a horizontal in-feed spout 14 and, are able, together, to lift all logs 12 in in-feed spout laying across gap 56 anywhere in the width of floor 16.

It will be apparent to those skilled in the art of wood chippers and their operations that many changes and substitutions may be made to the foregoing description of preferred embodiments without departing from the spirit and scope of the present invention, which is defined by the appended claims.

What is claimed is:

1. A wood chipper, comprising:
(a) an in-feed spout having a floor, a first side, an opposing second side, a width defined by said first side and said second side, an input end and an opposing feeding end, said in-feed spout having a major dimension running from said input end to said feeding end, said floor having a gap formed in said in-feed spout across said width of said in-feed spout;
(b) a chipper blade positioned to receive logs at said feeding end of said in-feed spout;
(c) a motor in operational connection with said chipper blade to rotate said chipper blade;
(d) an arm system having a first position external to said in-feed spout and proximate to said gap, and a second position inserted into said in-feed spout, said arm system crossing through said gap and across said width of said in-feed spout when moving from said first position to said second position and, when logs are on said in-feed spout, said arm system lifting said logs from said floor; and
(e) a ram system in operating connection with said arm system, said ram system moving said arm system from said first position to said second position.

2. The wood chipper as recited in claim 1, wherein said arm system further comprises a first arm and an opposing second arm, said first arm being positioned on said first side of said in-feed spout and said second arm being positioned on said second side of said in-feed spout, said first arm and said second arm extending toward each other across said width of said floor when said arm system is in said inserted second position.

3. The wood chipper as recited in claim 2, wherein said ram system further comprises two rams, a first ram on said first side and an opposing second ram on said second side of said floor, said first ram moving said first arm and said second ram moving said second arm.

4. The wood chipper as recited in claim 1, wherein said floor of said in-feed spout has an opening formed therein, and wherein said wood chipper further comprises a roller positioned to engage logs on said floor of said in-feed spout and to urge said logs from said input end to said feeding end.

5. The wood chipper as recited in claim 1, wherein said chipper blade has an axis and wherein said axis of said chipper blade is at an angle greater than zero with respect to said long dimension of said in-feed spout.

6. The wood chipper as recited in claim 5, wherein said axis of said chipper blade and said long dimension of said in-feed spout are both horizontal.

7. The wood chipper as recited in claim 1, further comprising a control system in operational connection with said ram system for moving said arm system between said first position and said second position.

8. The wood chipper as recited in claim 3, further comprising a cover over said feeding end of said in-feed spout.

9. The wood chipper as recited in claim 8, further comprising a bracket holding said first ram and said second ram in spaced relation to said gap of said in-feed spout, said bracket being carried by said cover.

10. A device for clearing jammed logs in a wood chipper, said wood chipper having a chipper blade and an in-feed spout positioned to feed logs into said chipper blade, said in-feed spout having a gap formed therein, said device comprising:
(a) at least one arm having a first position external to said in-feed spout of said wood chipper and proximate to said gap and a second position inserted parallel to said gap, said at least one arm crossing said gap when moving from said external first position to said inserted second position to lift logs on said in-feed spout;
(b) at least one ram in operating connection with said at least one arm, said at least one ram moving said each at least one arm from said first position to said second position to clear jammed logs on said in-feed spout;
(c) a bracket for securing and aligning said at least one ram with respect to said gap of said in-feed spout; and
(d) a control system in operative connection with said at least one ram for independently moving said at least one ram between said first position and said second position.

11. The device as recited in claim 10, wherein said at least one ram system further comprises two rams and said at least one arm further comprises two arms, each ram of said two rams operating one arm of said two arms.

12. The device as recited in claim 11, wherein said control system operates said two rams independently.

13. The device as recited in claim 10, wherein said at least one arm is one arm and said at least one ram is one ram, said one ram moving said one arm parallel to said gap, said ram being angled so as to cam said log on said in-feed spout upward as said one arm moves from said external position to said inserted position.

14. The device as recited in claim 10, wherein said wood chipper further comprises a cover over said in-feed spout and wherein said bracket is attached to said cover.

15. The wood chipper as recited in claim 14, wherein said cover carries a bracket and wherein said bracket secures said each ram of said plural rams and holds said each ram in alignment so that said each arm moved by said each ram is able to move through said gap.

16. A device for use with a chipper blade of a wood chipper, said device comprising:
(a) an in-feed spout to feed logs into a chipper blade, said in-feed spout having a width and a gap formed therein;
(b) a bracket in spaced relation to said gap of said in-feed spout;
(c) at least one ram secured to said bracket;
(d) at least one arm carried by said at least one ram, said at least one ram moving said each at least one arm from a first position external to said in-feed spout, through said gap, to a second position to clear jammed logs on said in-feed spout, said at least one arm lifting logs on said in-feed spout when moving to said second position, said at least one arm extending across the width of said in-feed spout when in said second position; and
(e) a control system in operative connection with said at least one ram for independently moving said at least one ram between said first position and said second position.

17. The device as recited in claim 16, further comprising a cover on said in-feed spout and wherein said bracket is carried by said cover.

18. The device as recited in claim 16, wherein said at least one arm is two arms and said at least one ram is two rams, said two arms together extending across the width of said in-feed spout when said two arms are in said second position.

19. The device as recited in claim 18, wherein said two arms move vertically through said gap of said in-feed spout from said first position to said second position.

20. The device as recited in claim 16, wherein said at least one arm is one arm and said at least one ram is one ram, said one arm being angled to cam a log on said in-feed spout upward when moving from said first position to said second position.
